(19) United States
(12) Patent Application Publication
(10) Pub. No.: US 2022/0065686 A1
(43) Pub. Date: Mar. 3, 2022

(54) DEVICE AND METHOD FOR MONITORING STATUS OF CABLE BARRIERS

(71) Applicant: VIOTEL LIMITED, Auckland (NZ)

(72) Inventor: Richard A. Lynch, Tasmania (AU)

(21) Appl. No.: 17/411,560

(22) Filed: Aug. 25, 2021

(30) Foreign Application Priority Data
Aug. 25, 2020 (AU) 2020903035

(51) Int. Cl. G01H 1/00; G01L 5/10; G01P 15/18

(52) U.S. Cl. CPC G01H 1/00; E01F 15/06; G01P 15/18; G01L 5/10

(57) ABSTRACT

There is provided a device and a method for monitoring a status of a cable barrier for a thoroughfare, the cable barrier including two or more cables, the device comprising a strain gauge adapted to detect a tension required to keep a pair of cables from the two or more cables deflected by the device; and an accelerometer adapted to detect vibration of the cable barrier, wherein the device is configured to monitor the status of the cable barrier based on the detected tension and the detected vibration.

### CROSS REFERENCE TO RELATED APPLICATIONS

This application claims the benefit of Australian Provisional Application No. 2020903035 entitled “A DEVICE AND METHOD FOR MONITORING STATUS OF CABLE BARRIERS” filed on Aug. 25, 2020, which is incorporated herein by reference in its entirety.

### TECHNICAL FIELD

The present invention relates generally to cable tension monitoring devices and particularly to a device and method for monitoring the status of cable barriers for a thoroughfare.

### BACKGROUND OF INVENTION

Barriers formed from various materials are used along one or both sides of thoroughfares such as roads and paths as a safety measure to not only provide a visual guide marking the metes and bounds of the thoroughfare, but more importantly, as a physical barrier to keep vehicles within their bounds and to prevent vehicles from colliding with other vehicles or obstacles.

Such barriers may be found along pedestrian paths, bicycle paths, local roads, highways and freeways. It will be appreciated that such barriers play a particular role in ensuring safety along thoroughfares carrying heavier traffic, larger volumes of traffic and traffic travelling at faster speeds. Moreover, such barriers are often strategically placed at particular locations where the risk of experiencing a loss of control of a vehicle are increased, e.g. on certain bends, slopes, and the like.

When formed from cable, such as wire rope or similar, and supported by spaced posts, such barriers require regular monitoring and maintenance to ensure sufficient tension is maintained in the cables to enable the barriers to act as a physical barrier to provide the requisite safety outcomes. Current cable barrier maintenance involves crews attending the relevant site, stopping or diverting traffic and measuring the cable tension of each individual cable at regular intervals. Such site visits are typically supplemented by scheduled drive-bys to visually detect any damage to the cable barriers.

Accordingly, it will be appreciated that maintenance of cable barriers is resource intensive in terms of both time and human resources. Moreover, unless a maintenance crew is notified of a barrier collision having occurred, a damaged barrier could go sometime without repair before that barrier is due for a scheduled maintenance check. This increases the risk that the barrier will not perform the function for which it was intended and could increase the risk of future collisions.

It would be desirable to at least ameliorate one or more shortcomings or disadvantages associated with currently available cable barriers discussed above, or to at least provide a useful alternative thereto.

A reference herein to a patent document or any other matter identified as prior art, is not to be taken as an admission that the document or other matter was known or that the information it contains was part of the common general knowledge as at the priority date of any of the claims.

### SUMMARY OF INVENTION

According to an aspect of the present invention, there is provided a device for monitoring a status of a cable barrier for a thoroughfare, the cable barrier including two or more cables, the device comprising a strain gauge adapted to detect a tension required to keep a pair of cables from the two or more cables deflected by the device; and an accelerometer adapted to detect vibration of the cable barrier, wherein the device is configured to monitor the status of the cable barrier based on the detected tension and the detected vibration.

In an embodiment, the accelerometer adapted to detect the vibration of the device further comprises the accelerometer determining a plurality of vibration samples of the cable barrier. The device is further configured to determine a short-term average and a long-term average of the determined plurality of vibration samples of the cable barrier and a ratio of the short-term average and the long-term average.

In another embodiment, the device is further configured to determine an impact duration based on the detected vibration. The impact duration is determined as a duration from a start of the ratio of the short-term average and the long-term average exceeding a first threshold to an end of the ratio of the short-term average and the long-term average falling below a second threshold.

In a further embodiment, the strain gauge measures a force required to maintain deflection of the pair of cables, the measured force being converted to an estimate of a sum of cable tensions based on a distance between a pair of posts, a distance between the pair of cables prior to being deflected by the device and an amount of deflection of the pair of cables caused by the device.

Preferably, the accelerometer is a triaxial accelerometer.

In an embodiment, the device comprises an attachment means connected to at least two sides of the strain gauge to attach the strain gauge on to the pair of cables.

Preferably, the device deflects the pair of cables substantially at a midpoint of the pair of cables. The pair of cables are substantially parallel to each other prior to being deflected by the device.

According to another aspect of the present invention, there is provided a method of monitoring a status of a cable barrier for a thoroughfare, the cable barrier including two or more cables, the method comprising detecting, using a strain gauge, a tension required to keep a pair of cables from the two or more cables deflected; detecting, using an accelerometer, a vibration of the cable barrier; and monitoring the status of the cable barrier based on the detected tension and the detected vibration.

In an embodiment, detecting the vibration of the cable barrier further comprises determining a plurality of vibration samples of the cable barrier, determining a short-term average and a long-term average of the determined plurality of vibration samples of the cable barrier and subsequently determining a ratio of the short-term average and the long-term average of the determined plurality of vibration samples of the cable barrier.

In another embodiment, the method further comprises determining an impact duration based on the detected vibration by determining a duration from a start of the ratio of the short-term average and the long-term average exceeding a first threshold to an end of the ratio of the short-term average and the long-term falling below a second threshold.

In an embodiment, the status of the cable barrier is at least any one of; normal or impact detected.

In an embodiment, the pair of cables extends between a pair of posts of the cable barrier.

In an embodiment, detecting the tension comprises measuring a force required to maintain deflection of the pair of cables, and converting the measured force to an estimate of a sum of cable tensions using a distance between the pair of posts, a distance between the pair of cables prior to being deflected by the device and the amount of deflection of the pair of cables caused by the device.

Preferably, the vibration of the device is detected using a triaxial accelerometer.

In an embodiment, the ratio of the short-term average and the long-term average of the plurality of vibration samples auto-adjusts to a background noise level.

### BRIEF DESCRIPTION OF DRAWINGS

The invention will now be described in further detail by reference to the accompanying drawings. It is to be understood that the particularity of the drawings does not supersede the generality of the description of the invention.

FIG. 1a shows a device for monitoring a status of a cable barrier for a thoroughfare according to an embodiment of the invention;

FIG. 1b shows a device for monitoring a status of a cable barrier for a thoroughfare according to another embodiment of the invention;

FIG. 2 shows a flow diagram of a method for monitoring a status of a cable barrier for a thoroughfare according to an embodiment of the invention;

FIG. 3a shows the device for monitoring a status of a cable barrier for a thoroughfare according to another embodiment of the invention;

FIG. 3b shows the device for monitoring a status of a cable barrier for a thoroughfare according to a further embodiment of the invention;

FIG. 4 shows a flow diagram of operation of the device of FIG. 1a, FIG. 1b according to an embodiment of the invention; and

FIG. 5 shows a flow diagram of installation of the device of FIG. 1a, FIG. 1b according to an embodiment of the invention.

A person skilled in the art will appreciate that elements in the figures are illustrated for simplicity and clarity and have not necessarily been drawn to scale. It will further be appreciated that the drawings may show only those specific details that are pertinent to understanding the embodiments of the present invention so as not to obscure the disclosure with details that will be readily apparent to those of ordinary skill in the art having the benefit of the description below.

### DETAILED DESCRIPTION

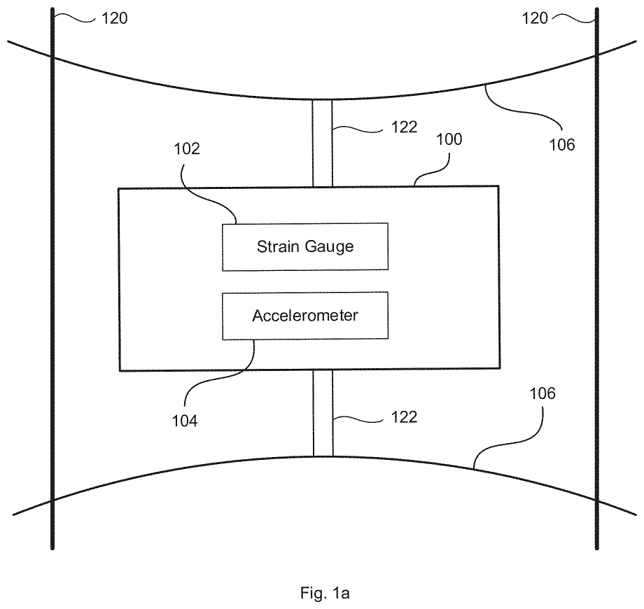

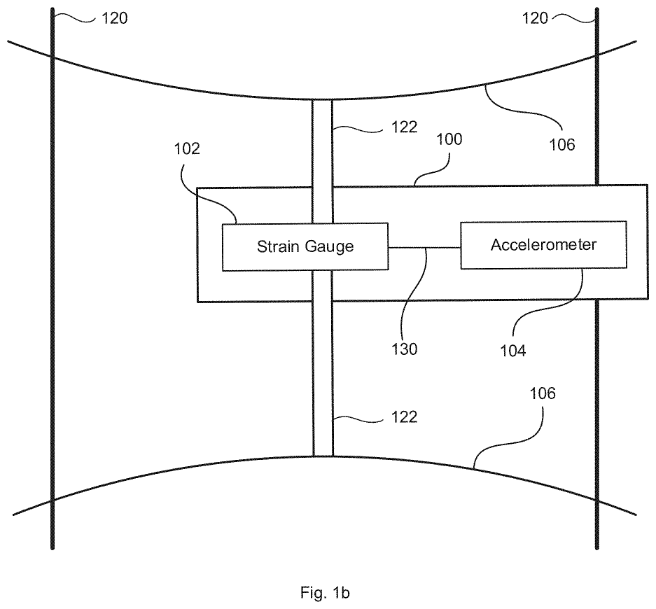

Referring firstly to FIG. 1a, there is shown a device 100 for monitoring the status of a cable barrier for a thoroughfare. In this illustrated example, the cable barrier to be monitored includes two or more cables such as a pair of cables 106. The device 100 includes a strain gauge 102 connected to attachment means 122. The attachment means 122 is attached to each of the two cables comprising the pair of cables 106 using sufficient tension to deflect the pair of cables towards each other. The strain gauge 102 is configured to detect the tension required to keep the pair of cables 106 deflected. The device 100 further comprises an accelerometer 104 to detect vibration of the cable barrier. The strain gauge 102 is electrically connected to the accelerometer 104. The device 100 is configured to determine the status of the cable barrier based on the detected tension and the detected vibration.

The accelerometer 104 detects vibration of the cable barrier by determining a plurality of samples, each representative of the vibration of the cable barrier during an interval in time. The number of samples determined by the accelerometer 104 is defined by a power management mode of the device 100 as described below. The device 100 determines a short-term average (hereinafter referred to as “STA”) and a long-term average (hereinafter referred to as “LTA”) of an absolute value of acceleration from the plurality of vibration samples. The LTA is a measure of the background vibration level, and the STA is a measure of the acceleration amplitude (aᵢ) for a short time period that has just passed. It will be appreciated that the background vibration level refers to a noise level in the background of the device 100.

In an exemplary embodiment, the STA and LTA are calculated as follows:

STAᵢ=[(N−1)×STAᵢ₋₁+abs(aᵢ)]/N with N=5 (1)

LTAᵢ=[(N−1)×LTAᵢ₋₁+abs(aᵢ)]/N with N=1000 (2)

where N is the number of samples.

The device 100 then determines a ratio of the STA and the LTA (hereinafter referred to as the “STA:LTA ratio”) for the plurality of samples. The device 100 monitors the status of the cable barrier based on the detected tension and the STA:LTA ratio. The STA:LTA ratio of the plurality of vibration samples of the cable barrier may be alternatively referred to as a “triggering ratio”.

In a preferred embodiment, rectified samples of the vibration are used to determine the STA and the LTA. Where the accelerometer is a triaxial accelerometer, the plurality of samples are rectified by using simple absolute value of the acceleration with the direct current (DC) value removed, for each of the x-, y-, and z-axis components.

When a vehicle, or other object such as a bicycle, person, animal, boulder, stone or the like collides with the cable barrier, elastic waves are generated by the impact and travel up and down the cable barrier with the two or more cables acting as a wave guide. As a consequence, a sudden and strong signal having a long duration is produced. An example of a sudden and strong signal having a long duration is an impulsive signal having a dominant frequency in the range of 0.1 to 10 Hz, maximum acceleration above 0.2 g and duration longer than 3 seconds.

The device 100 is further configured to determine an impact duration based on the detected vibration. The impact duration is measured as the duration when the STA:LTA ratio exceeds a first threshold to when the STA:LTA ratio falls below a second threshold. In an exemplary embodiment, the first threshold is 8 and the second threshold is 4. However, it will be appreciated that the first and second thresholds may vary depending on factors such as, but not limited to, the mass, shape and speed of the object colliding with the cable barrier, the material from which the cables are formed, force of the impact of collision of the vehicle or other colliding object.

In a preferred embodiment of the invention, the accelerometer 104 is a triaxial accelerometer i.e. the vibration of the cable barrier is detected in each of the three directions (along x-axis, y-axis and z-axis). However, it will be appreciated that satisfactory results could be achieved using a biaxial accelerometer. It will be appreciated that vibration of the cable barrier is considered to substantially correspond to vibration of the device 100.

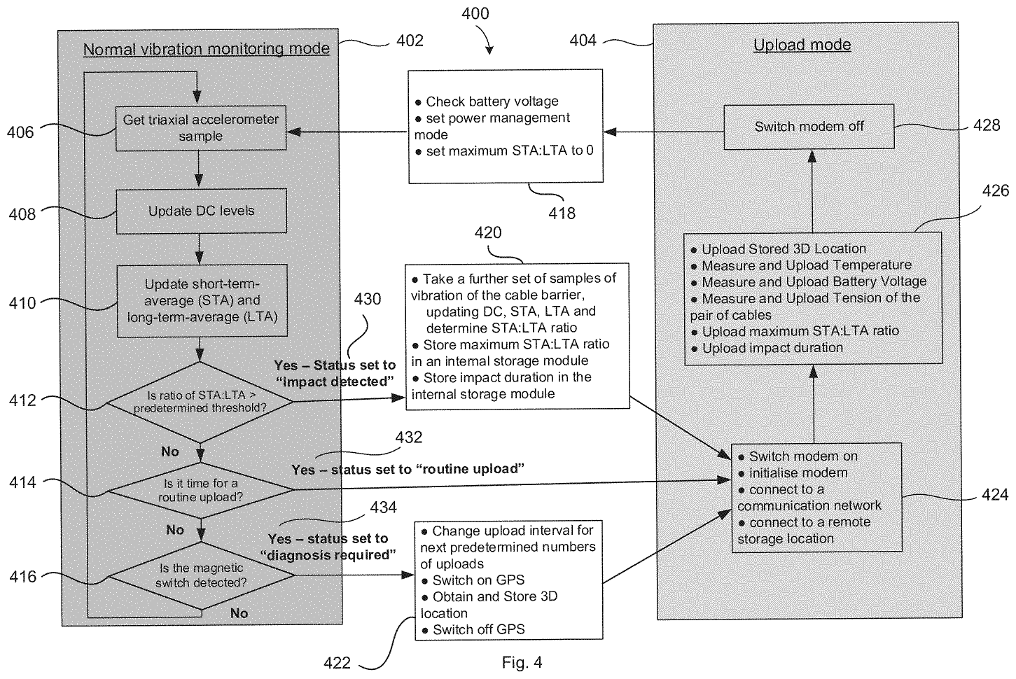

The data collected by the device in situ is used to determine a status of the cable barrier. The status could be at least any one of normal or impact detected. It will be appreciated that status of the cable barrier in effect corresponds to the status of the strain gauge 102 where the tension is detected, together with the status of the accelerometer 104, where the vibration is detected. The possible statuses will be described in more detail below with reference to FIG. 4.

Referring still to FIG. 1a, there is shown a pair of spaced apart posts 120 between which the pair of cables 106 are supported and extend. Generally, a cable barrier will comprise a number of spaced apart posts with the cables slidingly supported by each post 120 to substantially maintain a predetermined height of the cable. Typically, the post will be spaced apart at regular intervals. However, it will be appreciated that the device could equally be used to monitor the status of a cable barrier supported between a single pair of posts 120. Moreover, it will be appreciated that more than two cables could extend between the spaced apart posts of the cable barrier, with two, three or four substantially parallel cables being representative of a typical configuration. In a particular embodiment of the invention, the cables 106 are wire rope cables. However, other types of cables could be used to achieve similar results.

The cables 106 are substantially parallel to each other. However, once the strain gauge 102 is attached to the pair of cables 106 i.e. at least two sides of the strain gauge 102 being attached to the two cables, the pair of cables will be deflected towards each other by way of the strain gauge 102 applying some tension to those cables as is shown in FIG. 1a.

The strain gauge 102 measures a force required to maintain deflection of the pair of cables 106. The measured force is then converted to an estimate of a sum of cable tensions based on a distance between the pair of posts 120 (known), a distance between the pair of cables 106 prior to being deflected (i.e, the unconnected condition wherein the pair of cables are not connected by the device 100, i.e. the strain gauge 102 (known) and an amount of deflection of the pair of cables caused by the device i.e. the strain gauge 102 in the connected condition (i.e. where the pair of cables are connected together by the strain gauge 102 by way of the attachment means and are thereby deflected towards each other). It is an advantage of the invention that cable tension is measured indirectly i.e. via deflection.

In an exemplary embodiment, the measured force F can be converted to an estimate of the sum of cable tensions as follows:

F=8×T1×T2×(D−Db)/(L×(T1+T2)), (3)

where T1 is the tension of one of the pair of cables 106, T2 is the tension of the other of the pair of cables, L is the distance between the pair of posts 120, D is the vertical distance between the pair of cables and Db is the distance from the top to the bottom of the attachment means 122 when the pair of cables are connected together by the strain gauge 102, thereby deflecting the pair of cables towards each other.

Typically, the deflection of the pair of cables 106 in the connected condition will be a few centimetres. In a non-limiting example, the deflection of the pair of cables is more than 2 cm and less than 15 cm. In another non-limiting example, the distance between the pair of supporting posts 120 is about 3 m and in the connected condition, the deflection of each of the pair of cables 106 is about 6 cm. The force measured by the strain gauge 102 is about 8% of a sum of the tensions of each of the pair of cables 106. In this example, a summed tension of the pair of cables 106 is about 40 kN.

The attachment means 122 deflects the pair of cables 106 substantially at a midpoint of the pair of cables 106. In an exemplary embodiment, the attachment means 122 is a stainless steel band and is used to deflect the pair of cables 106. While stainless steel is an example of a preferred material due to its availability and weatherproof properties, other suitable materials, e.g, plastic-covered mild steel could be used to produce similar results. Further, it will be appreciated that other forms of the attachment means 122 (such as, but not limited to, hook, clasp, clip) may also be used without departing from the spirit of the invention.

The STA:LTA ratio of the plurality of samples of the detected vibration may auto-adjust to compensate for a background noise level around the device 100. For example, contributors to background noise may be wind, turbulence or air temperature. Accordingly, the device 100 determines the STA:LTA ratio above a predetermined background noise level so as to reduce the probability of false positives.

Referring next to FIG. 1b, there is shown a device 100 for monitoring the status of a cable barrier for a thoroughfare according to an alternate embodiment of the invention. The device 100 comprises a strain gauge 102. The strain gauge 102 is connected to the attachment means 122. The attachment means 122 is attached to each of the two cables comprising the pair of cables 106 thereby deflecting the pair of cables towards each other. Accordingly, the strain gauge 102 is configured to detect a tension required to keep the pair of cables 106 deflected by the device 100. The device 100 further comprises an accelerometer 104 to detect vibration of the cable barrier and is placed on either (a) one of the posts (as shown in FIG. 1b) or (b) one or both of the pair of cables 106. The strain gauge 102 is further electrically connected to the accelerometer 104 using a suitable electrical wiring 130 as shown in FIG. 1b. The device 100 is configured to determine the status of the cable barrier based on the detected tension and the detected vibration.

In one configuration of the device according to an embodiment of the invention, the strain gauge 102 and the accelerometer 104 are connected to the pair of cables 106 from both sides of the device 100 using the attachment means 122. In another configuration, the strain gauge 102 is connected to the pair of cables 106 by way of the attachment means 122 while the accelerometer 104 is connected to either (a) one of the pair of cables 106, (b) both of the pair of cables 106, or (c) the post 120 (e.g. by clamping the accelerometer 104 on to the post). Accordingly, it will be appreciated that based on the various configurations, two or more sides of the device 100 may be connected to the pair of cables 106.

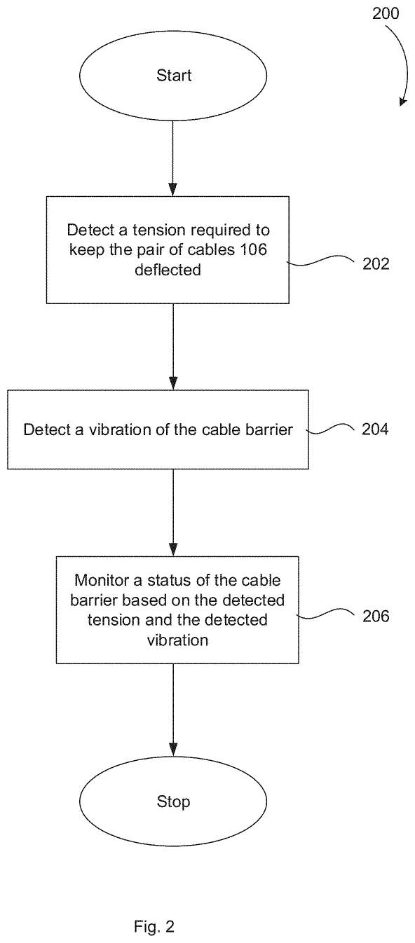

Referring now to FIG. 2, there is shown a flow diagram of a method 200 for monitoring a status of a cable barrier. The method 200 involves the steps of (1) detecting a tension required to keep the pair of cables 106 deflected 202, (2) detecting a vibration of the cable barrier 204 and (3) monitoring the status of the cable barrier based on the detected tension and the detected vibration 206.

Detecting the vibration of the cable barrier 204 involves determining a plurality of samples of the vibration of the cable barrier, wherein each sample is representative of the vibration of the cable barrier during an interval in time. Detecting the vibration further includes determining the STA and the LTA of the plurality of samples. Subsequently the triggering ratio can be determined.

The method 200 further comprises determining the impact duration based on the detected vibration as described with reference to FIG. 1a or FIG. 1b.

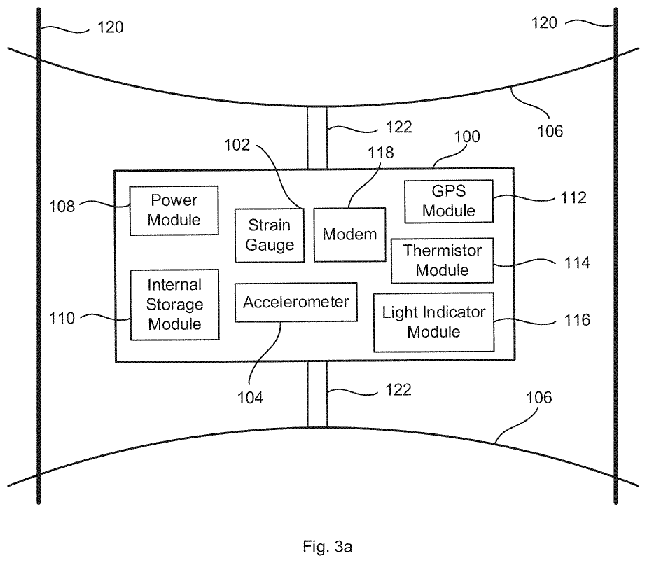

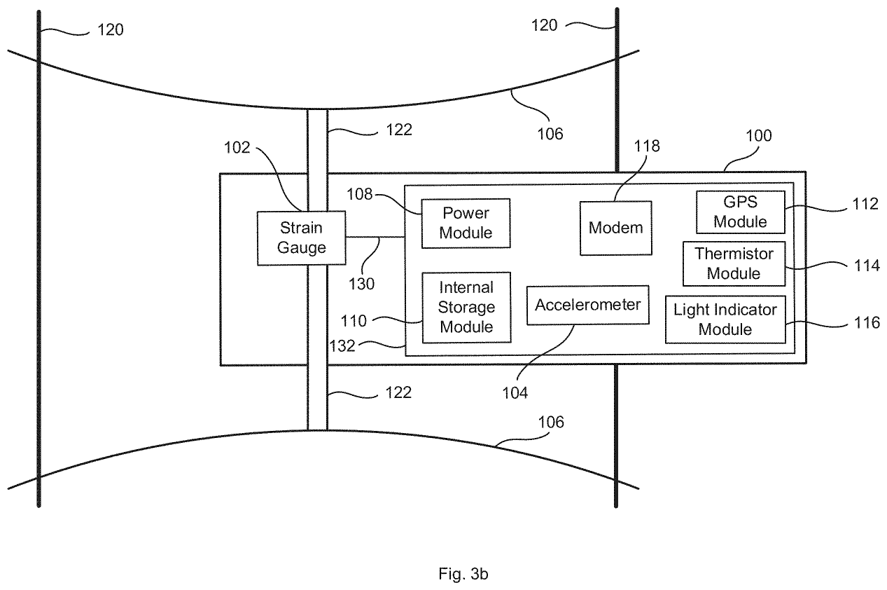

Referring now to FIG. 3a, there is shown a more detailed schematic of the cable status monitoring device 100. The device 100 comprises a strain gauge 102. The device 100 further comprises an accelerometer 104, a power module 108 to power the device, a thermistor module 114 to measure a temperature of the device, a Global Positioning System (GPS) module 112 to determine the three-dimensional location of the device, a light indicator module 116 to confirm normal operation of the device and a modem 118 to transmit data. The device 100 also includes an internal storage module 110 to store data including the tension of the pair of cables 106 detected by strain gauge 102, the STA:LTA ratio, the temperature measured by thermistor module 114 and the three-dimensional location determined by the GPS module 112. Analog and digital temperature compensation may be applied to the device 100.

The power module 108 comprises an internal rechargeable battery and a solar panel. In a preferred embodiment, the device 100 is designed for autonomous operation for a period of at least five years. Battery voltage of the power module 108 of the device 100 may affect the number of samples of the vibration being determined as well as the frequency of routine upload of data from the device to a remote storage location. The power module 108 has four power management modes—normal battery mode, medium battery mode, low battery mode and critical battery mode. Normal battery mode of the power module 108 has a battery voltage greater than 4.0V. In normal battery mode, 50 samples of vibration data are collected per second and data is uploaded to the remote storage location once per hour. Medium battery mode has a battery voltage less than or equal to 4.0V and greater than 3.8V. In medium battery mode, 50 samples of vibration data are collected per second and data is uploaded to the remote storage location once every 6 hours. Low battery mode has a battery voltage less than or equal to 3.8V and greater than 3.6V. In low battery mode, 50 samples of vibration data are collected per second and data is uploaded to the remote storage location once every 24 hours. Critical battery mode has a battery voltage less than or equal to 3.6V. In critical battery mode, 12.5 samples of vibration data are collected per second and data is uploaded to the remote storage location once every 48 hours, i.e. to conserve battery power.

Referring now to FIG. 3b, there is shown a detailed schematic of the cable status monitoring device 100 according to an alternate embodiment of the invention. In this embodiment, the elements of the device 100 (collectively shown as a unit 132) other than the strain gauge 102 are placed on either (a) one of the posts (as shown in FIG. 3b) or (b) one or both of the pair of cables 106. The unit 132 is connected to the strain gauge 102 using a suitable electrical wiring 130 as shown in FIG. 3b. The unit 132 includes an accelerometer 104, a power module 108 to power the device, a thermistor module 114 to measure a temperature of the device, a Global Positioning System (GPS) module 112 to determine the three-dimensional location of the device, a light indicator module 116 to confirm normal operation of the device and a modem 118 to transmit data. The unit 132 also includes an internal storage module 110 to store data including the tension of the pair of cables 106 detected by strain gauge 102, the STA:LTA ratio, the temperature measured by thermistor module 114 and the three-dimensional location determined by the GPS module 112. Analog and digital temperature compensation may be applied to the device 100.

Referring now to FIG. 4, there is shown a detailed flow diagram 400 showing operation of the device 100 according to an embodiment. The device 100 has two modes of operation—normal vibration monitoring mode 402 and upload mode 404.

The upload mode 404 begins at step 424 where device 100 sends a signal to a modem 118 to switch on and initialize the modem. The modem 118 connects the device 100 to a communication network and a remote storage location. Then, in step 426, one or more of a maximum STA:LTA ratio of the plurality of vibration samples of the cable barrier, impact duration, temperature measured by the thermistor module 114, battery voltage of the power module 108, tension of the pair of cables 106 as measured by strain gauge 102 and the three-dimensional location of the device 100 as determined by the GPS module 112 are uploaded to the remote storage location. In step 428, the modem 118 is switched off. The communication network may support LTE Cat M1 and the modem 118 may be an LTE modem. In alternate embodiments, the communication network supports Sigfox or LoraWAN or satellite. Further, the remote storage location may be a cloud computing platform such as that provided by Amazon Web Services (AWS)™ which can provide secure data transmission using public/private key encryption.

In the normal vibration monitoring mode 402, the cable barrier can have at least any one of the following statuses: normal or impact detected. Further statuses may include routine upload and diagnosis required as described in more detail below.

In step 406, device 100 initially determines a plurality of vibration samples of the cable barrier using accelerometer 104. Then, at step 408, the direct current (DC) levels of the device 100 are updated to account for the slow variation in the zero-line DC of the accelerometer over time due to one or more of temperature, age, battery voltage change. In step 410, the device 100 updates the STA and the LTA based on the plurality of vibration samples determined at step 406. Next, at step 412, when the device 100 determines that the STA:LTA ratio of the plurality of vibration samples is greater than or equal to a predetermined threshold i.e. the device was subjected to an impact, the status of the cable barrier is determined as “impact detected” 430. In an exemplary embodiment, the predetermined threshold is 8.

The detected impact can be a small impact or a large impact. Consequently, the status will be a small local impact or a large distance impact. A non-limiting example of a small impact or a small local impact is a small stone striking the cable barrier. A non-limiting example of a large impact or a large distance impact is a vehicle colliding with the cable barrier 500 m from the cable barrier. While the large or large distance impacts may have similar peak accelerations as a small or small local impact, the impact duration of the large or large distance impacts are usually longer. Impact duration of small impact or small local impact may be less than 0.5 seconds. Accordingly, taking into account both the STA:LTA ratio and the impact duration, false positives can be eliminated or at least reduced.

The small or large impacts are differentiated by the STA:LTA ratio and the impact duration of the plurality of vibration samples detected by the accelerometer 104.

At step 420, once the status of the cable barrier is determined as “impact detected” (Le. when the STA:LTA ratio is greater than or equal to the predetermined threshold) 430, a subsequent set of vibration samples is collected and the DC level updated. The STA and LTA of the subsequent vibration samples are determined and a maximum STA:LTA ratio is determined and stored in the internal storage module 110 of the device 100. The impact duration is also stored in the internal storage module 110. For example, a set of subsequent vibration samples may comprise 100 readings.

The device 100 then switches from the normal vibration monitoring mode 402 to step 424 of the upload mode 404 and steps 424 to 428 are carried out. Once the modem 118 is switched off at step 428, the battery voltage of the power module 108 is measured and the power management mode of the power module 108 is set accordingly together with a maximum STA:LTA ratio to 0 418 before the device 100 switches from the upload mode 404 back to the normal vibration monitoring mode 402.

At step 412, if the STA:LTA ratio of the plurality of vibration samples is less than the predetermined threshold i.e. no impact is detected, the status of the cable barrier will be any one of “normal”, “routine upload” or “diagnosis required” as described in more detail below.

While the STA:LTA ratio of vibration samples remains less than the predetermined threshold, at step 414, the device 100 checks if it is time for routine upload. If so, the status of the cable barrier is determined to be “routine upload” 432. It will be appreciated that the status of the cable barrier substantially corresponds to the status of the strain gauge 102 and the status of the accelerometer 104. The frequency of routine upload depends on a power management mode of the device 100 as described below.

If the cable monitoring device 100 is in the “routine upload” state, the device switches from the normal vibration monitoring mode 402 to the upload mode 404 and steps 424 to 428 are carried out. Once the modem 118 is switched off at step 428, the battery voltage of the power module 108 is measured and the power management mode of the power module 108 is set accordingly together with a maximum STA:LTA ratio set to 0 418 before the device 100 switches from the upload mode 404 back to the normal vibration monitoring mode 402.

If, however, at step 414, the device 100 determines that the routine upload is not yet scheduled, the device checks at step 416, if a magnetic switch is detected. The magnetic switch can be detected when the installer of the device 100 waves a magnetic key over the part of the device 100 where a magnetic sensor (reed switch) is located, If a magnetic switch is detected, the status of the cable barrier is determined to be “diagnosis required” 434. The upload interval for a next predetermined number of uploads is changed. Changing the upload frequency may be desirable to calibrate the device 100 by changing the tension of the cables and taking an independent measurement. Setting a short upload frequency allows for a much quicker test of the device 100. The GPS module 112 is switched on to obtain and store the three-dimensional location of the device 100 in the internal storage module 110 and at step 422, the GPS module is switched off before the device switches from the normal vibration monitoring mode 402 to the upload mode 404 in which steps 424 to 428 are carried out. The upload interval may be changed, for example, to 10 seconds for the next 20 uploads. Again, once the modem 118 is switched off at step 428, the battery voltage of the power module 108 is measured and the power management mode of power module 108 is set accordingly together with a maximum STA:LTA ratio set to zero 418 before the device 100 switches from the upload mode 404 back to the normal vibration monitoring mode 402.

When the status of the cable barrier is none of “impact detected”, “routine upload” or “diagnosis required”, the status of the cable barrier is determined to be “normal”.

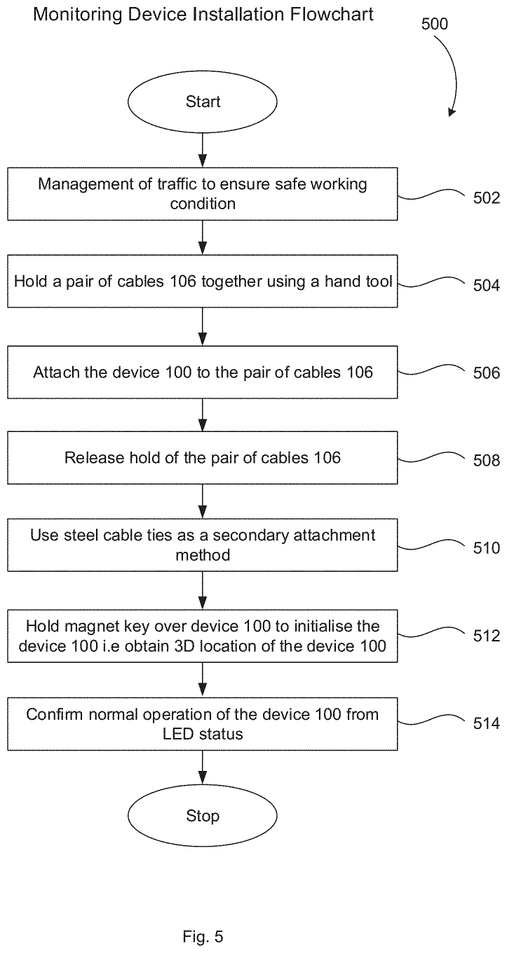

Referring to FIG. 5, there is shown a flow diagram 500 demonstrating the steps involved in installation of the device 100. Initially, in step 502, traffic is managed by maintenance crew to ensure a safe working conditions for installation of the monitoring device 100. Next, at step 504, the pair of cables 106 extending between the pair of posts 120 are held together using a hand tool such as, but not limited to, a coil spring compressor set. At step 506, while the pair of cables 106 is held by the hand tool, the attachment means 122 on to which the strain gauge 102 is mounted is attached to the pair of cables. The accelerometer 104 (and other elements of the device 100 in the unit 132) may also attached to the cable using steel cable ties or similar. At step 508, once the attachment means 122 is attached to each cable in the pair of cables 106, the hand tool holding the pair of cables 106 is released. The tension of the pair of cables 106 holds the attachment means 122 in place. Next, at step 512, a magnetic key is positioned over device 100 to initialise the device i.e. includes obtaining the three-dimensional location of the device using GPS module 112. Finally, at step 514, the light indicator module 116 of device 100 is used to confirm normal operation of the device.

Using the method described by reference to FIG. 5, installation of the device 100 on-site can be achieved in under 5 minutes

The device 100 may include an 8-bit microcontroller to which the strain gauge 102, accelerometer 104, power module 108, internal storage module 110, GPS module 112, thermistor module 114, modem 118 and light indicator module 116 are connected. In an exemplary embodiment, the microcontroller is STM32L495ZG, the accelerometer 104 is LIS2DS12TR, light indicator module 116 is an LED indicator such as EASV3015RGBA0 and thermistor module 114 is TMP102.

Possible advantages of the present invention may include enabling remote monitoring of cable barriers by way of routine upload of operational parameters associated with the cable barriers (such as temperature, tension etc.), quicker notification of impacts on the cable barriers at the remote location to enable rapid deployment of maintenance crew to attend to any damage, and indirect measurement of cable tension via deflection. Accordingly, the number of physical visits required by the crew to inspect the cable barriers can be reduced while cable barrier damage can be rectified in a quicker and more cost-effective manner without necessitating witness reports of impacts to initiate a maintenance call.

The present invention may further enable varied routine upload schedules for different installation locations of the device 100 to be setup e.g. more frequent routine uploads for accident-prone areas. Installation of the cable monitoring device is quicker and data transmission between the device and the remote storage location can be encrypted for secure communication.

Other possible advantages of the present invention may include low-cost of manufacturing of the device 100 and operation of the device 100 and ultra-low power consumption (in the order of less than 3 mW average).

Where any or all of the terms “comprise”, “comprises”, “comprised” or “comprising” are used in this specification (including the claims), they are to be interpreted as specifying the presence of the stated features, integers, steps or components, but not precluding the presence of one or more other features, integers, steps or components.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

What is claimed is:

1. A device for monitoring a status of a cable barrier for a thoroughfare, the cable barrier including two or more cables, the device comprising:
a strain gauge adapted to detect a tension required to keep a pair of cables from the two or more cables deflected by the device; and
an accelerometer adapted to detect vibration of the cable barrier, wherein the device is configured to monitor the status of the cable barrier based on the detected tension and the detected vibration.

2. The device according to claim 1, wherein the accelerometer adapted to detect the vibration of the device further comprises the accelerometer determining a plurality of vibration samples of the cable barrier.

3. The device according to claim 2, wherein the device is further configured to determine a short-term average and a long-term average of the determined plurality of vibration samples of the cable barrier.

4. The device according to claim 3, wherein the device is further configured to determine a ratio of the short-term average and the long-term average.

5. The device according to claim 4, wherein the device is further configured to determine an impact duration based on the detected vibration.

6. The device according to claim 5, wherein the impact duration is determined as a duration from a start of the ratio of the short-term average and the long-term average exceeding a first threshold to an end of the ratio of the short-term average and the long-term average falling below a second threshold.

7. The device according to claim 1, wherein the strain gauge measures a force required to maintain deflection of the pair of cables, the measured force being converted to an estimate of a sum of cable tensions based on a distance between a pair of posts, a distance between the pair of cables prior to being deflected by the device and an amount of deflection of the pair of cables caused by the device.

8. The device according to claim 1, wherein the accelerometer is a triaxial accelerometer.

9. The device according to claim 1, further comprising an attachment means connected to at least two sides of the strain gauge to attach the strain gauge on to the pair of cables.

10. The device according to claim 1, wherein the device deflects the pair of cables substantially at a midpoint of the pair of cables.

11. A method of monitoring a status of a cable barrier for a thoroughfare, the cable barrier including two or more cables, the method comprising:
detecting, using a strain gauge, a tension required to keep a pair of cables from the two or more cables deflected;
detecting, using an accelerometer, a vibration of the cable barrier; and
monitoring the status of the cable barrier based on the detected tension and the detected vibration.

12. The method according to claim 11, wherein detecting the vibration of the cable barrier further comprises determining a plurality of vibration samples of the cable barrier.

13. The method according to claim 12, further comprising determining a short-term average and a long-term average of the determined plurality of vibration samples of the cable barrier.

14. The method according to claim 13, further comprising determining a ratio of the short-term average and the long-term average of the determined plurality of vibration samples of the cable barrier.

15. The method according to claim 14, wherein the method further comprises determining an impact duration based on the detected vibration.

16. The method according to claim 15, wherein determining the impact duration comprises determining a duration from a start of the ratio of the short-term average and the long-term average exceeding a first threshold to an end of the ratio of the short-term average and the long-term falling below a second threshold.

17. The method according to claim 11, wherein the status of the cable barrier is at least any one of: normal or impact detected.

18. The method according to claim 11, wherein the pair of cables extends between a pair of posts of the cable barrier.

19. The method according to claim 18, wherein detecting the tension comprises measuring a force required to maintain deflection of the pair of cables, and converting the measured force to an estimate of a sum of cable tensions using a distance between the pair of posts, a distance between the pair of cables prior to being deflected by the device and the amount of deflection of the pair of cables caused by the device.

20. The method according to claim 14, wherein the ratio of the short-term average and the long-term average of the plurality of vibration samples auto-adjusts to a background noise level.
